(19) United States
(12) Patent Application Publication
(10) Pub. No.: US 2015/0332595 A1
(43) Pub. Date: Nov. 19, 2015

(54) INTEGRATED USER AUTHENTICATION AND PROCTORING SYSTEM FOR ONLINE AND DISTANCE EDUCATION COURSES AND METHODS OF USE

(71) Applicant: Salah Shakir, Carterville, IL (US)

(72) Inventor: Salah Shakir, Carterville, IL (US)

(21) Appl. No.: 14/280,638

(22) Filed: May 18, 2014

(51) Int. Cl. G09B 7/00; G06Q 50/20

(52) U.S. Cl. CPC G09B 7/00; G06Q 50/20

(57) ABSTRACT

The present invention relates to an integrated student authentication and proctoring system for online and distance education programs, methods of producing the same, and methods of utilizing the same. In particular, the present invention relates to a software plugin or API that integrates with an existing Learning Management System (LMS) to provide customizable settings that enables one party (e.g., an academic institution or instructor) to take photos, compare photo from existing database, video, audio recordings, screen shots, thumb and finger print scan, retina scan, and/or provide security questions that must be answered by another party (e.g., student being tested) in order to authenticate the user and deter academic dishonesty.

### CROSS REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

This invention relates to an application for an integrated user authentication and proctoring system for online and distance education courses and methods of use. More specifically, the disclosed invention relates to online and distance education courses and is a software plug-in or API that integrates with an existing Learning Management System. it can be used as a plug-in, API, or as an independent system.

Cheating, along with all other forms of academic dishonesty are problems that educators have sought to overcome since time immemorial. Students have historically engaged in cheating in many different ways, including having another person (presumably with more knowledge of the subject matter) take an exam in their place. Online and distance learning programs pose additional challenges to educators that need to ensure the student that receives credit is the one that was tested, especially when exams are given over the internet such that the student is allowed, and somewhat required, to take the exam in any location they desire.

The accreditation standards require educators to take an active role in verifying and authenticating the student participants, but remain open to new technologies that would enhance security. While there is little research to support claims that online students cheat significantly more than face-to-face students, research does demonstrate that there is a perception that the opportunity to cheat as an online student is greater than for their on-campus counterparts.

In particular, the present invention relates to a system XProctor which can be used as a software, plug-in or API that integrates with an existing Learning Management System (LMS) to provide customizable settings that enables one party (e.g., an academic institution or instructor) to take photos, compare photo from existing database, video, prompted audio recordings, compare user's audio from existing database, unprompted audio, screen shots, thumb and finger print scan, retina scan, and/or provide security questions that must be answered by another party (e.g., student being tested) in order to authenticate the user and deter academic dishonesty.

The proctor system is software which enables its users to take exams online with the help of the software. These systems have become very common and are used by various educational institutions to conduct exams even if the students are not present at the examination centers. This system can be downloaded by various computers which have been marked. The users can then give their exams on it under the supervision of instructors at the specially designated centers. This invention, i.e., integrated user authentication and proctoring system for online and distance education courses, can be used to authenticate individuals so that only the authorized individuals have access to the information and other material and for that, there is an authentication system specially designed for it.

The current invention provides for easy integrated user authentication and proctoring system for online and distance education courses. The software integrates with the learning management system and provides authentication to one party (educational system, university etc.) which is provided by the user in order to use the database or in case of giving examinations.

No invention to the knowledge of the inventor has disclosed an apparatus which has features as that of the present invention. No other invention has provided for a better user interface, robustness, and enhanced security features. The present invention provides a unique methodology and software plug-in that can be applied to and used with any existing learning management system (e.g., Moodle, Black Board, etc.) to authenticate the online user and protect against academic dishonesty.

The limitations and non-effectiveness of the prior art has been overcome by the instant invention as described below.

### BRIEF SUMMARY OF THE INVENTION

The invention is a software application, a plug-in or API or can also work as an independent system that integrates with an existing Learning Management System which helps in user authentication and deters academic dishonesty.

The present invention provides a unique methodology and software plug in, API or can also work as an independent system that can be applied to and used with any existing learning management system (e.g., Moodle, Black Board, etc.) to authenticate the online user and protect against academic dishonesty.

The present invention uses a software plug-in with any existing learning management system that can periodically, and at a time unknown to the user take a photo of the student, take video of the student (e.g., 5 seconds of video), take a thumb or fingerprint scan, take a retinal scan, take audio recordings of the student, take screen shots of the student's computer screen(s), ask the student to provide personal data, and to store the information and data collected into a database.

It is the object of the invention to provide for a software application with the help of which the persons who want to log in order to use the data can be authenticated, and then they can be allowed have access to the data from a remote location.

It is also the object of the present invention to provide for a plug-in, API or a software application which integrates with the learning management system and then first authenticates the user by taking his/her to take photos, compare photos from existing database, video, audio recordings, screen shots, thumb and finger print scan, retina scan, and/or provide security questions that must be answered by another party (e.g., student being tested) in order to authenticate the user and deter academic dishonesty.

These and other features, objects and advantages of the present invention will be readily apparent to persons of ordinary skill in the art upon reading the entirety of this disclosure, which includes the accompanying drawings and claims.

### BRIEF DESCRIPTION OF THE SEVERAL VIEWS OF THE DRAWING

FIG. 1 shows the flowchart of how the actual software application would work when the user logs on to the website to access the information.

FIG. 1—is a process flow diagram of embodiment of the method by which user start the process of being authenticated and proctored and all biometric capturing. For photo, a face recognition will occur to authenticate the user with registered photo of the user. Also, audio comparison with user's registered audio will occur to authenticate the user. All captured biometric will be saved on the server side of the system.

FIG. 2—is an overview of the process. The user will connect to the Xproctor server in the cloud using either an Id/password or face recognition process to start using Xproctor process during taking test, exam, quiz, or provide the organization of audit trail of use. After authenticating the user existence in the Xproctor system, a client software will be downloaded to the client's desktop after user's consent agreement. The Xproctor process start taking biometric data with face recognition and audio for authentication. The number, length, of intervals of the biometric scan are known only to the user's organization and not to the user. When last biometric is taken the Client's system will be ended automatically. The user may end the system manually if needed by right click on the letter “X” in the tray and select “exit”. The organization may connect with Xproctor with proper identification to review biometric data of the user as and when required.

### DETAILED DESCRIPTION OF THE INVENTION

In the present disclosure, numerous specific details are provided, such as examples of module, components, and method, to provide a thorough understanding of embodiments of the invention. Persons of ordinary skill in the art will recognize, however, that the invention can be practiced without one or more of the specific details. In other instances, well-known details are not shown.

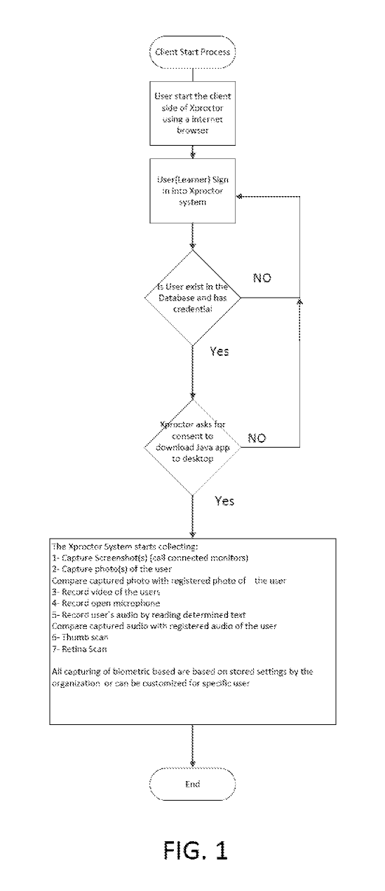

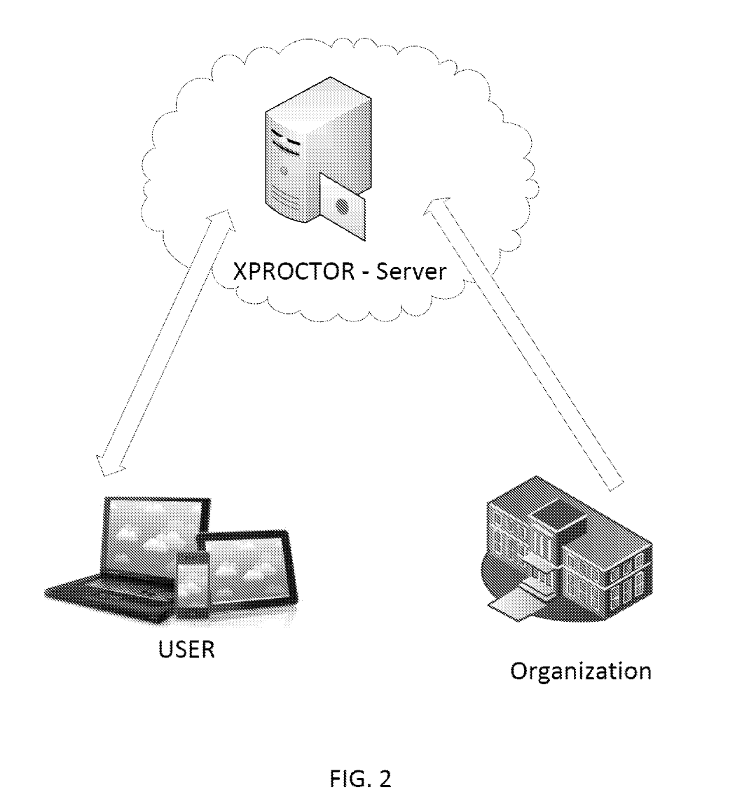

FIG. 1 shows the flowchart, i.e., how the invention which can be used as a plug-in, software application or even as an independent system would work when the user logs on the website in order to access the information from a remote location. The software API that is integrated with the learning management system then authenticates the user before granting access to the database which prevents dishonesty and cheating by the students.

The term “learning management system” (also referred to as “LMS”) as used herein means a software application for the administration, documentation, tracking, reporting and delivery of e-learning education courses or training programs. Examples of LMS platforms include, but are not limited to Moodle and Blackboard. Many colleges and universities use LMS's to deliver online courses and supplement on-campus courses. Many private companies use LMS's to deliver online training as well as automate record-keeping and employee registrations. LMS's range from systems for managing training and educational records to software programs for distributing online courses over the internet. API stands for Application Programming Interface and used as connection from the LMS to the software of this invention.

The present invention provides a unique methodology and can be used as a software, API, plug-in or even as an independent system that can be applied to and used with any existing learning management system (e.g., Moodle, Black Board, etc.) to authenticate the online user and protect against academic dishonesty. The present invention uses a software plug-in with any existing learning management system that can periodically, and at a time unknown to the user take a photo of the student, take video of the student (e.g., 5 seconds of video), take a thumb or fingerprint scan, take a retinal scan, take prompted and unprompted audio recordings of the student, take screen shots of the student's computer screen, ask the student to provide personal data, and to store the information and data collected into a database. The taken photo and prompted audio will be compared with registered photo and audio of the user.

By taking photos, video, audio recordings, retinal scans, thumb and finger print scans, and screen shots of a student at random times unknown to the student during the time-frame in which user authentication is desired, the academic institution is able to greatly deter academic dishonesty and catch violators. Additionally, photographs taken during authentication can be compared either at a later date or immediately, from an existing database of photographs. Further, the settings (e.g., which authentication methods to implement and how frequently) can be customized as desired. The invention may be installed on a server or it may be installed on the student's PC and from there send collected data to a server for storage.

The present invention does slightly reduce student privacy as their photograph, video, or audio recordings may be taken at any time authentication is desired by the academic institution. However, the level to which privacy is reduced when the invention is in use is on a par with the level of privacy traditional students taking an in-person proctored exam experience.

Further, as institutions struggle to meet accreditation guidelines and ensure academic honesty for online and distance programs, there is a need to authenticate student identities; reducing the level of privacy to that of traditional in-person students by implementing the present invention is a way to solve the problem by authenticating the user and ensuring academic integrity. The present invention provides a simple, straight-forward way for educators to authenticate user identity and enhance academic honesty for on-line and distance learning courses.

The term “academic dishonesty” as used herein refers to any type of cheating that occurs in relation to a formal academic exercise. Academic dishonesty includes, but is not limited to the following: plagiarism, fabrication, deception, cheating, bribery, paid services, sabotage, professional misconduct, impersonation, etc.

While specific embodiments of the present invention have been provided, it is to be understood that these embodiments are for illustration purposes and not limiting. Many additional embodiments will be apparent to persons of ordinary skill in the art reading this disclosure.

What is claimed is:

1. An integrated user authentication and proctoring system for online and distance education courses and methods of use.

2. The integrated user authentication and proctoring system for online and distance education courses of claim 1, wherein the integrated user authentication and proctoring system can be used as a software, plug-in or API and it can even work as an independent system that integrates with an existing Learning Management System.

3. The integrated user authentication and proctoring system for online and distance education courses of claim 1, wherein the integrated user authentication and proctoring system can be customized to include all or some settings for data collection.

4. The integrated user authentication and proctoring system for online and distance education courses of claim 3, wherein the data collection settings can be selected from the following:
a. video recording(s),
b. photograph(s),
c. Prompted audio recording(s) and comparing to existing database
d. Unprompted audio recording(s)
e. screen shot(s),
f. security question(s),
g. Thumb print scan(s),
h. Finger print scan(s)
i. Retina scan(s), and
j. Photo comparison(s) from existing database.

5. The data collection settings of claim 4, wherein the settings can be further customized by the following:
a. frequency of data collection, and
b. Length of the time data is collected.

6. The integrated user authentication and proctoring system for online and distance education courses of claim 3, wherein the customized data collection settings are unknown to the user from which data is being collected.

7. A method for use of the integrated user authentication and proctoring system of claim 1 for online and distance education courses.
